(19) United States
(12) Patent Application Publication
(10) Pub. No.: US 2012/0079376 A1
(43) Pub. Date: Mar. 29, 2012

(54) SYSTEM AND METHOD FOR CONTROL PANEL TEXT OVERLAY ELIMINATION USING DISPLAY ICONS WITH LANGUAGE TAGS

(75) Inventors: Heinz Erwin Grellmann, Beaverton, OR (US); Suhyung Song, Wilsonville, OR (US); John B. Gilbert, Portland, OR (US); Kuangti Ted Cheng, Beaverton, OR (US)

(73) Assignee: Xerox Corporation, Norwalk, CT (US)

(21) Appl. No.: 12/892,460

(22) Filed: Sep. 28, 2010

(51) Int. Cl. G06F 3/048; G06F 3/01

(52) U.S. Cl. 715/703; 715/830

(57) ABSTRACT

A device, including: a specially programmed computer including a processor; a screen; and a control panel with a plurality of push buttons and respective icons for the push buttons. The processor is for: displaying, on the screen, the respective icons; and displaying, for each respective icon and on the screen, a respective description, in a first language, of a respective function, represented by said each respective icon, implementable by the device.

### TECHNICAL FIELD

The present disclosure relates to a device having buttons for controlling functions related to the device. In particular, the present disclosure relates to the use of displays on a screen for a device such as a printer, a multi-function device, or a wireless communications device, to replace text overlays or other fixed markings on a control panel for the device.

### BACKGROUND

Devices, such as printers, multi-function devices (MFDs), and wireless communications devices (WCDs), often use small screens, such as liquid-crystal diode (LCD) screens and multiple buttons to access functions for the devices. The number of such buttons can become quite large, especially for MFDs and WCDs. For example, an MFD can include functionality such as copying, printing, scanning, and faxing. A word label is provided on control panels for the devices for each button describing the function related to the button. Such devices, which may be produced by a single manufacturer at one or a limited number of production facilities, can be sold to multiple different countries or regions in which different respective languages are spoken. Thus, for devices in the various countries or regions, word labels must be presented in the respective local language, necessitating different control panel overlays or similar measures for each language. Providing different control panel overlays or similar measures in the respective local languages adds cost to each product sold and complicates logistical and regionalization issues with respect to hardware.

Icons are sometimes used with the devices noted above; however, icons are not well suited for such devices, since users often have only occasional interface with the device and, in general, there are no universal, or even widely accepted, standards for relating icons to designated functions. Thus, icons by themselves fail to provide adequate information regarding a button and the function associated with the button.

### SUMMARY

According to aspects illustrated herein, there is provided a method for operating a device including a specially programmed computer, a screen, and a control panel with a plurality of push buttons and respective icons for the push buttons, including: displaying, using the processor, the respective icons on the screen; and displaying, on the screen and using the processor, descriptions, in a first language, of functions represented by the respective icons and implementable by the device.

According to aspects illustrated herein, there is provided a device, including: a specially programmed computer including a processor; a screen; and a control panel with a plurality of push buttons and a respective icon for each push button in the plurality of push buttons, the respective icon located adjacent said each push button. The processor is for: displaying the respective icons on the screen; and displaying, on the screen, respective descriptions, in a first language, of respective functions represented by the respective icons and implementable by the device.

According to aspects illustrated herein, there is provided a method for operating a device including a specially programmed computer with a processor, a memory element, a screen, and a control panel with a plurality of push buttons and respective icons for the push buttons, including: storing, in the memory element, descriptions, in a plurality of languages, of functions represented by the respective icons and implementable by the device; receiving, using the processor, an input selecting a first language from among the plurality of languages; displaying, using the processor, the respective icons on the screen; displaying, using the processor, the descriptions on the screen in the first language; receiving, using the processor, an input selecting a second language from among the plurality of languages; displaying, using the processor, the descriptions on the screen in the second language; receiving, using the processor, an input from a push button from the plurality of push buttons; and implementing, using the device, a respective function represented by a respective icon for the push button.

According to aspects illustrated herein, there is provided a device, including: a specially programmed computer including a processor and a memory element; a screen; and a control panel with a plurality of push buttons and respective icons for the push buttons. The memory element is for storing descriptions, in a plurality of languages, of functions represented by the respective icons and implementable by the device. The processor is for: receiving an input selecting a first language from among the plurality of languages; displaying the respective icons on the screen; displaying the descriptions on the screen in the first language; receiving an input selecting a second language from among the plurality of languages; displaying the descriptions on the screen in the second language; receiving an input from a push button from the plurality of push buttons; and implementing a respective function represented by a respective icon for the push button.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a schematic block diagram of a device with icons and a screen for displaying textual information;

FIG. 2 is a pictorial representation of a control panel for the device shown in FIG. 1; and,

FIG. 3 is a detail illustrating a portion of the screen shown in FIG. 1 with descriptions in three different languages.

### DETAILED DESCRIPTION

As used herein, the following terms are intended to be broadly construed as follows:

Icon: Any visual, pictorial, or graphical image. A graphic symbol, for example, a simple picture, that denotes a program or a command or a data file or a concept in a graphical user interface.

Function: a series of computer executable commands.

Wireless Communications Device (WCD): a communications device that receives or transmits via a non-wired medium, such as radio frequency. A WCD can include, but is not limited to an AM or FM radio device, a television, cell phones, portable phones, and devices, such as laptop computers and PDAs interfaced with a wireless network, for example, a LAN. Applicable formats, standards or protocols, include Ethernet (or IEEE 802.3), SAP, ATP, Bluetooth, and TCP/IP, TDMA, CDMA, 3G and 4G.

Furthermore, as used herein, the words “printer,” “printer system”, “printing system”, “printer device” and “printing device” as used herein encompasses any apparatus, such as a digital copier, bookmaking machine, facsimile machine, multi-function machine, etc. which performs a print outputting function for any purpose, while “multi-function device” and “MFD” as used herein is intended to mean a device which includes a plurality of different imaging devices, including but not limited to, a printer, a copier, a fax machine and/or a scanner, and may further provide a connection to a local area network, a wide area network, an Ethernet based network or the internet, either via a wired connection or a wireless connection. An MFD can further refer to any hardware that combines several functions in one unit. For example, MFDs may include but are not limited to a standalone printer, a server, one or more personal computers, a standalone scanner, a mobile phone, an MP3 player, audio electronics, video electronics, GPS systems, televisions, recording and/or reproducing media or any other type of consumer or non-consumer analog and/or digital electronics.

Moreover, although any methods, devices or materials similar or equivalent to those described herein can be used in the practice or testing of these embodiments, some embodiments of methods, devices, and materials are now described.

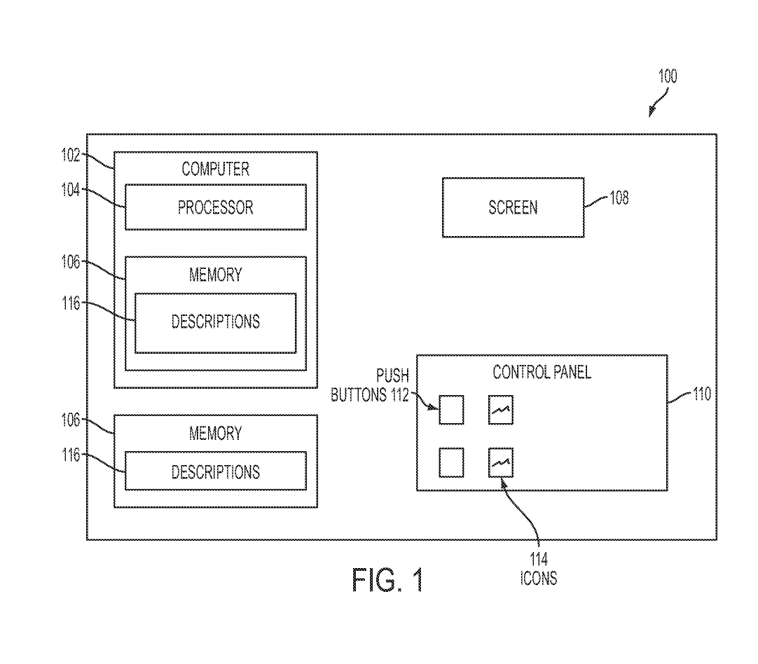

FIG. 1 is a schematic block diagram of device 100 with icons and a screen for displaying textual information.

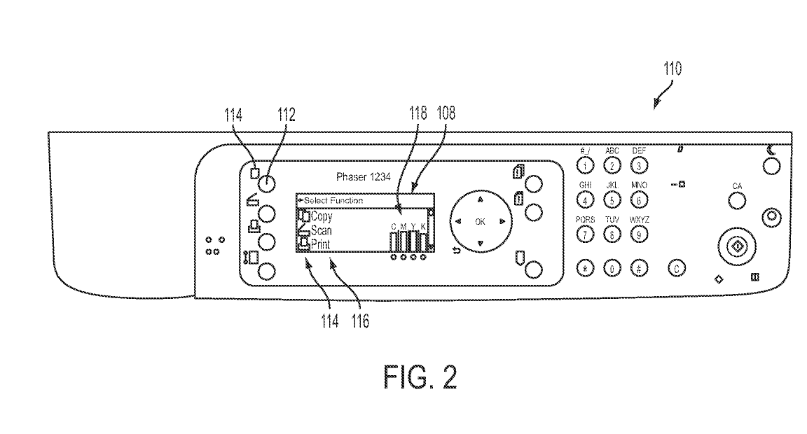

FIG. 2 is a pictorial representation of the control panel for the device shown in FIG. 1. The following should be viewed in light of FIGS. 1 and 2. Device 100 includes specially programmed computer 102 with processor 104 and memory element 106, screen 108, and control panel 110 with plurality of push buttons 112 and respective icons 114 for the push buttons. Icons 114 provide visual representations of the functions associated with buttons 112. Memory element 106 stores descriptions 116, in at least one language, of functions represented by the icons and implementable by the device. The processor displays the icons on the screen and also displays the descriptions, in a particular language, on the screen.

Computer 102 and processor 104 can be any computer or processor, respectively, known in the art. In one embodiment, memory element 106 is located within device 100, but not in computer 102. Screen 108 can be any screen known in the art. Push button 112 can be any push button known in the art. Icons 114 are not limited to any particular size, shape, representation, presentation, or configuration. In one embodiment, the icons are adjacent the input devices on the control panel. In one embodiment, the icons are on the push buttons. Push buttons 112 and icons 114 can be related to any function known in the art, including, but not limited to, copying, scanning, printing, faxing, job status, system status, address book, pause, redial, speed dial, data, error information, volume control, resolution, start, darkness, number of copies, reduce/enlarge, quality, collation, and paper selection.

As further described infra, descriptions 116 can be in any language known in the art and can be in any format known in the art, including, but not limited to, any combination of text, graphs, tables, or graphics. In one embodiment, descriptions 116 are in a single language. In one embodiment, descriptions 116 are in a plurality of languages. In one embodiment, the processor is for receiving an input selecting a language from among the plurality of languages in which description 116 is stored and displaying, on the screen, descriptions 116 in the selected language. For example, if descriptions 116 are stored in English, French, and German and the processor receives an input selecting German, descriptions 116 are displayed in German on the screen. That is, device 100, with the same hardware (computer and control panel), provides descriptions 116 on the same screen in any language in which the descriptions are stored in the memory element. Thus, the processor can receive another input selecting a different language from among the plurality of languages in which description 116 is stored and display, on the screen, description 116 in the selected different language.

Device 100 enables optimal usability and customer acceptance by providing an intuitive association of graphical representations and related functions. Specifically, device 100 relates a same icon 114 to a term or function, in a variety of languages, explaining the function associated with the icon in the form of an informational display on the screen. Displayed icons and descriptions change along with menu selections. Required icon association need be accomplished only when a function set is accessible or valid. In one embodiment, a scroll bar used to access function lists longer than the display screen.

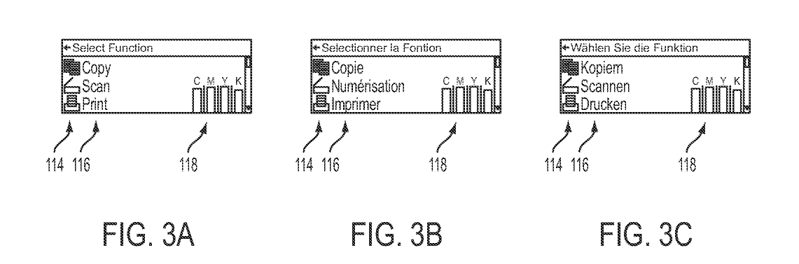

FIGS. 3A through 3C are details illustrating the screen shown in FIG. 1 with descriptions in three different languages. The following should be viewed in light of FIGS. 1 through 3C. Thus, device 100 provides a solution to the problem noted supra, for example, the need to provide control panels with unique language overlays specific to local or regional languages. For example, push buttons 112, requiring a description to explain and identify respective functions, have respective icons on the control panel. Icons are displayed on the screen along with appropriate information 116. For the same push buttons 112 and icons 114, FIGS. 3A, 3B, and 3C show descriptions 116 in English, French, and German, respectively.

In one embodiment, graphical representations 118, for example, tables, common to multiple icons, or menus, are shown in a portion of the screen. Representations 118 can be deleted, added to, or modified depending on the icon selected. For example, in FIGS. 3A through 3C, the same graph 118 regarding toner ink amounts is shown. In FIGS. 3A through 3C, the same respective letters (C, Y, M, K) are used for each of the inks; however, it should be understood that text in representations 118 can be modified, for example, so as to be in the same language in which descriptions 116 are displayed. In one embodiment, representations 118 remain in visible, for example, in a fixed position, as icons and descriptions are scrolled on the screen.

In one embodiment, representations 118 are not dependent on the activation of any particular push button. In one embodiment, the processor is for displaying, on the screen, graphical information, or representation, 118 regarding functionality of the device and receiving an input selecting a push button. The processor modifies, as needed, the graphical information to include graphical information regarding the push button and displaying, on the screen, the modified graphical information. For example, for various push buttons 112, related to general printing functions, representation 118, regarding toner ink, is presented.

The following should be viewed in light of FIGS. 1 through 3. The following describes a method for operating a device including a specially programmed computer, a screen, and a control panel with a plurality of push buttons and respective icons for the push buttons. Although the method is presented as a sequence for clarity, no order should be inferred from the sequence unless explicitly stated. The method includes: displaying, using the processor, the respective icons on the screen; and displaying, on the screen and using the processor, descriptions, in a first language, of functions represented by the respective icons and implementable by the device.

In one embodiment, the method includes: receiving, using the processor, an input from a push button from the plurality of push buttons; and implementing, using the device, a function represented by a respective icon for the push button. In one embodiment, the device is selected from the group consisting of a printer, a multi-function device, and a wireless communications device.

In one embodiment, the device or the specially programmed computer includes a memory element and the method includes: storing, in the memory element, descriptions, in a plurality of languages, of the functions represented by the respective icons and implementable by the device; and receiving, using the processor, an input selecting the first language from among the plurality of languages. Displaying the descriptions in the first language includes displaying the descriptions in the first language in response to receiving the input selecting the first language. In one embodiment, the method includes: receiving, using the processor, an input selecting a second language, different from the first language, from among the plurality of languages; and displaying the descriptions on the screen in the second language. In one embodiment, the method includes: displaying, using the processor, a representation, regarding functionality of the device, on the screen; scrolling, using the processor, the respective icons on the screen; and maintaining, using the processor, a fixed position on the screen for the display of the representation as the respective icons are scrolled.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What we claim is:

1. A method for operating a device including a specially programmed computer with a processor, a screen, and a control panel with a plurality of push buttons and respective icons for the push buttons, comprising:
displaying, using the processor, the respective icons on the screen; and,
displaying, on the screen and using the processor, descriptions, in a first language, of functions represented by the respective icons and implementable by the device.

2. The method of claim 1 further comprising:
receiving, using the processor, an input from a push button from the plurality of push buttons; and,
implementing, using the device, a function represented by a respective icon for the push button.

3. The method of claim 1 wherein the device includes a memory element, the method further comprising:
storing, in the memory element, descriptions, in a plurality of languages, of the functions represented by the respective icons and implementable by the device; and,
receiving, using the processor, an input selecting the first language from among the plurality of languages, wherein displaying the descriptions in the first language includes displaying the descriptions in the first language in response to receiving the input selecting the first language.

4. The method of claim 3 further comprising:
receiving, using the processor, an input selecting a second language, different from the first language, from among the plurality of languages; and,
displaying, using the processor, the descriptions on the screen in the second language.

5. The method of claim 1 wherein the device is selected from the group consisting of a printer, a multi-function device, and a wireless communications device.

6. The method of claim 1 further comprising:
displaying, using the processor, a representation, regarding functionality of the device, on the screen;
scrolling, using the processor, the respective icons on the screen; and,
maintaining, using the processor, a fixed position on the screen for the display of the representation as the respective icons are scrolled.

7. A device, comprising:
a specially programmed computer including a processor;
a screen; and,
a control panel with a plurality of push buttons and a respective icon for each push button in the plurality of push buttons, the respective icon located adjacent said each push button, wherein the processor is for:
displaying the respective icons on the screen; and,
displaying, on the screen, respective descriptions, in a first language, of respective functions represented by the respective icons and implementable by the device.

8. The device of claim 7 wherein the processor is for:
receiving an input from a push button from the plurality of push buttons; and,
implementing a respective function represented by a icon for the icon.

9. The device of claim 7 further comprising a memory element for storing the descriptions, in a plurality of languages, of the functions represented by the respective icons and implementable by the device, wherein:
the processor is for receiving an input selecting the first language from among the plurality of languages; and,
displaying the descriptions in the first language includes displaying the descriptions in response to receiving the input selecting the first language.

10. The device of claim 9 wherein the processor is for:
receiving an input selecting a second language from among the plurality of languages; and,
displaying the descriptions on the screen in the second language.

11. The device of claim 7 wherein the device is selected from the group consisting of a printer, a multi-function device, and a wireless communications device.

12. The device of claim 7 wherein the processor is for:
displaying, using the processor, a representation, regarding functionality of the device, on the screen;
scrolling, using the processor, the respective icons on the screen;
maintaining, using the processor, a fixed position on the screen for the display of the representation as the respective icons are scrolled.

13. A method for operating a device including a specially programmed computer with a processor, a memory element, a screen, and a control panel with a plurality of push buttons and respective icons for the push buttons, comprising:
storing, in the memory element, descriptions, in a plurality of languages, of functions represented by the respective icons and implementable by the device;
receiving, using the processor, an input selecting a first language from among the plurality of languages;
displaying, using the processor, the respective icons on the screen;
displaying, using the processor, the descriptions on the screen in the first language;
receiving, using the processor, an input selecting a second language from among the plurality of languages;
displaying, using the processor, the descriptions on the screen in the second language;
displaying, using the processor, a representation, regarding functionality of the device, on the screen;
scrolling, using the processor, the respective icons on the screen;
maintaining, using the processor, a fixed position on the screen for the display of the representation as the respective icons are scrolled;
receiving, using the processor, an input from a push button from the plurality of push buttons; and,
implementing, using the device, a respective function represented by a respective icon for the push button.

14. A device, comprising:
a specially programmed computer including a processor and a memory element;
a screen; and,
a control panel with a plurality of push buttons and respective icons for the push buttons, wherein:
the memory element is for storing descriptions, in a plurality of languages, of functions represented by the respective icons and implementable by the device; and,
the processor is for:
receiving an input selecting a first language from among the plurality of languages;
displaying the respective icons on the screen;
displaying the descriptions on the screen in the first language;
receiving an input selecting a second language from among the plurality of languages;
displaying the descriptions on the screen in the second language;
displaying a representation, regarding functionality of the device, on the screen;
scrolling the respective icons on the screen;
maintaining a fixed position on the screen for the display of the representation as the respective icons are scrolled;
receiving an input from a push button from the plurality of push buttons; and,
implementing a respective function represented by a respective icon for the push button.
